(19) United States
(12) Patent Application Publication
(10) Pub. No.: US 2011/0198144 A1
(43) Pub. Date: Aug. 18, 2011

(54) ELECTRIC BICYCLE AND MOTOR THEREOF

(75) Inventors: Shih-Hsin Hsu, Taipei County (TW); Yee-Pien Yang, Taipei City (TW); Shih-Hsiang Chien, Yilan County (TW)

(73) Assignee: INDUSTRIAL TECHNOLOGY RESEARCH INSTITUTE, Hsinchu (TW)

(21) Appl. No.: 12/888,229

(22) Filed: Sep. 22, 2010

Related U.S. Application Data
(60) Provisional application No. 61/303,777, filed on Feb. 12, 2010.

(51) Int. Cl. B62M 6/65

(52) U.S. Cl. 180/206.6

(57) ABSTRACT

An electric bicycle includes a frame having at least one supporting member, at least one wheel having a shaft fixed to the supporting member and a hub rotatable about the shaft, and at least one slim motor having a rotor coupled to the hub and rotating about an axis aligned with the shaft, wherein the slim motor drives the hub to rotate about the shaft.

### CROSS REFERENCE TO RELATED APPLICATIONS

This application claims the benefit of U.S. Provisional Application No. 61/303,777, filed on Feb. 12, 2010.

### TECHNICAL BACKGROUND OF THE PRESENT DISCLOSURE

1. Technical Field of the Present Disclosure

The present disclosure relates to an electric bicycle, and in particular relates to an electric bicycle operated by a slim motor.

2. Description of the Related Art

For a conventional electric bicycle modified from a traditional bike, a motor is mounted in a wheel hub, usually the rear wheel hub, to rotate the wheel. However, before the motor is mounted to the hub, spokes of the traditional bicycle must be first demounted. Thus, when the motor is remounted, the spokes are re-fixed to the hub one by one, which requires a lot of time for assembly. Also, since wheels have different specifications for different bicycle brands, it is necessary to adjust the motor design for each different bicycle brand, which increases manufacturing costs.

There is another structure for the conventional electric bicycle, wherein the motor is fixed to a frame of the bike, and the wheel is rotated by a chain, a belt or gears coupled to the motor. However, the motor mounted to the frame may cause the bicycle to be imbalanced and occupy considerable space. Also, the durability of the frame may be weakened due to the installation of the motor. In addition, riding the bicycle may be more difficult due to the considerable weight and size of the motor.

Taiwan (R.O.C.) patent No. 1296596 discloses a driving mechanism for an electric bicycle comprising a motor and a modified structure of a pedal shaft which is connected to a wheel by a chain. Note that the frame is not modified. Meanwhile, Taiwan (R.O.C.) patent No. M356689 discloses a transmission wheel disposed on a front wheel or a rear wheel of a bike. Motors are disposed on a frame of the bicycle to drive the transmission wheel to rotate the front and rear wheels.

For the design of motors installed in the hub of a bike, Taiwan (R.O.C.) patent No. 352804 discloses an improved structure of a motor having improved silicon steel, coils, and magnets, forming a slim supersonic motor, which can be disposed on a front or rear wheel to serve as an engine. Meanwhile, Taiwan (R.O.C.) patent No. 313554 discloses an extra-slim electric motor in which heavy silicon steel and coil are replaced by a minor film and film coil. The extra-slim electric motor can be disposed on a front or rear wheel to serve as an engine.

Additionally, U.S. Pat. No. 5,368,122 discloses a DC motor with bevel pinions, a driving mechanism and a transmission collar which is installed on a rear triangular support mechanism. The transmission collar is rotated by the DC motor and the bevel pinions. The mechanism produces little noise and a smooth ride. Also, in U.S. Pat. No. 6,412,800, a kit including an electric motor, a control, and gears is mounted below a pedal axle of a bicycle to power a bicycle and U.S. Pat. No. 6,131,683 discloses an electric bicycle comprising a DC flat type motor utilizing an axial magnetic flux, which rotates a wheel by means of a control circuit, a pedal load sensor, pedal rotation speed sensor, a torque sensor, a speed reduction mechanism, transmission device and gears. In U.S. Pat. No. 585,753, an electric motor, a controller and a transmission mechanism are disposed in a rear wheel hub of a bicycle.

In the described patents, the electric motor must be mounted on the frame of a bicycle and be coupled to a wheel thereof via gears or a transmission mechanism, which results in a high cost and increased weight. Alternatively, the electric motor may be mounted in the hub of the bike. However, spokes of the bicycle must be re-fixed to the hub one-by one for remounting, which requires a lot of time for assembly.

Referring to FIG. 1, a conventional electric bicycle 10 usually has an outer-rotor type motor 12 mounted in a hub 14 of a wheel 16. The motor 12 has a considerable weight and must be mounted in the hub 14. Also, before the motor 12 is mounted to the hub 14, spokes 18 of the traditional bicycle must be first demounted. After the motor 12 is mounted in the hub 14, the spokes 18 are re-fixed to the hub 14. As the motor 12 is an outer-rotor type motor, it is difficult for heat generated by the copper coil to dissipate via the housing of the motor 12. Thus, demagnetization of the motor 12 easily occurs due to overheating. In addition, since torque generated by the motor 12 is proportional to its weight, when a large torque is desired, a large sized motor is needed.

### TECHNICAL SUMMARY OF PRESENT DISCLOSURE

The present disclosure provides an electric bicycle comprising a slim motor connected to the hub via a coupling element, wherein the slim motor is mounted near the hub. No transmission mechanism is needed. In addition, since the slim motor is mounted on the brake disc, it is not necessary to modify the frame. The slim motor is lighter than typical electric motors, which makes riding of the electric bicycle convenient.

An embodiment of an electric bicycle of the present disclosure comprises a frame comprising at least one supporting member, at least one wheel comprising a shaft fixed to the supporting member and a hub rotatable about the shaft, and at least one slim motor comprising a rotor coupled to the hub and rotating about an axis aligned with the shaft, wherein the slim motor drives the hub to rotate about the shaft. The rotor is coupled to the hub by a coupling element. The coupling element is an adapter tightly fitted to the rotor.

The adapter comprises a connecting portion having a first screw hole corresponding to a second screw hole formed on the rear hub, and a fitting portion connected to the connecting portion and tightly fitted to the rotor of the slim motor. A bolt passes through the first and second screw holes to fix the adapter to the hub. The fitting portion is perpendicular to the connecting portion.

The slim motor further comprises a housing having a disc shape with a through hole through which the axis passes, and a stator disposed in the housing and corresponding to the rotor, wherein the rotor is disposed in the housing and around the through hole. The fitting portion extends into the through hole and is tightly fitted with the rotor. The through hole is formed at the center of the disc shape.

A detailed description is given in the following embodiments with reference to the accompanying drawings.

### BRIEF DESCRIPTION OF DRAWINGS

The present disclosure can be more fully understood by reading the subsequent detailed description and examples with references made to the accompanying drawings which are given by way of illustration only, and thus are not limitation of the present disclosure and wherein:

FIG. 1 is a schematic view of a conventional electric bicycle with an electric motor;

FIGS. 2a and 2b depict a slim motor for the electric bicycle of the present disclosure;

FIG. 3 is a schematic view of an electric bicycle (rear drive) of the present disclosure;

FIG. 4 is a schematic view of an electric bicycle (front drive) of the present disclosure;

FIG. 5 is a schematic view of an electric bicycle (rear and front drive) of the present disclosure; and

FIG. 6 is a cross section view of a slim motor joining a hub of an electric bicycle of the present disclosure.

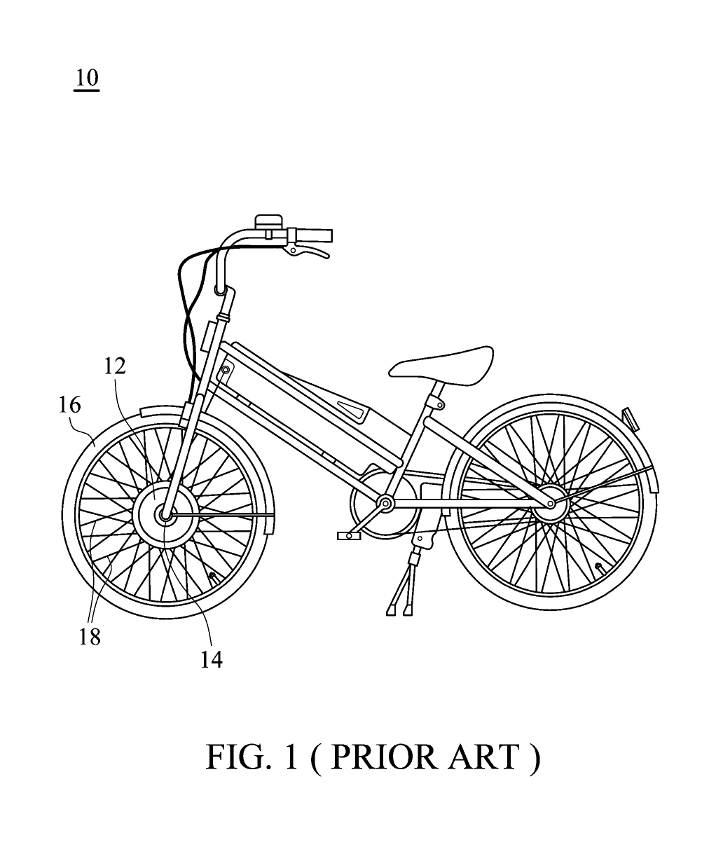

### DESCRIPTION OF THE EXEMPLARY EMBODIMENTS

To solve the described problems, a slim motor is provided for the electric bicycle of the present disclosure. The slim motor is coupled to the wheel and has an axis aligned with a shaft of the wheel. For example, the axis is mounted to the brake disc which is fixed to the wheel hub. The torque generated by the motor rotates the wheel directly, without a transmission mechanism. In this way, the slim motor does not occupy additional space of the bicycle. Since the slim motor is not mounted in the hub, there is no need to demount the spokes of the wheel from the hub and remount them. When the bicycle has a quick release device and brake disc, the slim motor of the present disclosure can be quickly and conveniently mounted to the bicycle to reduce the cost and time for assembly.

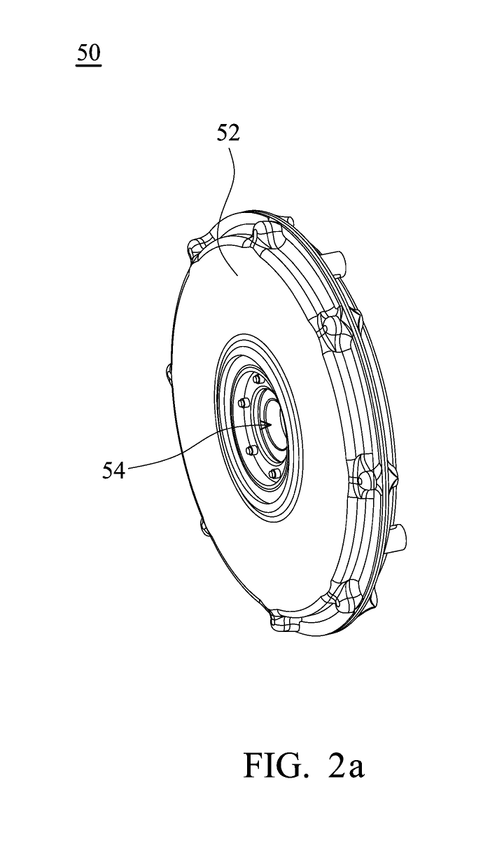

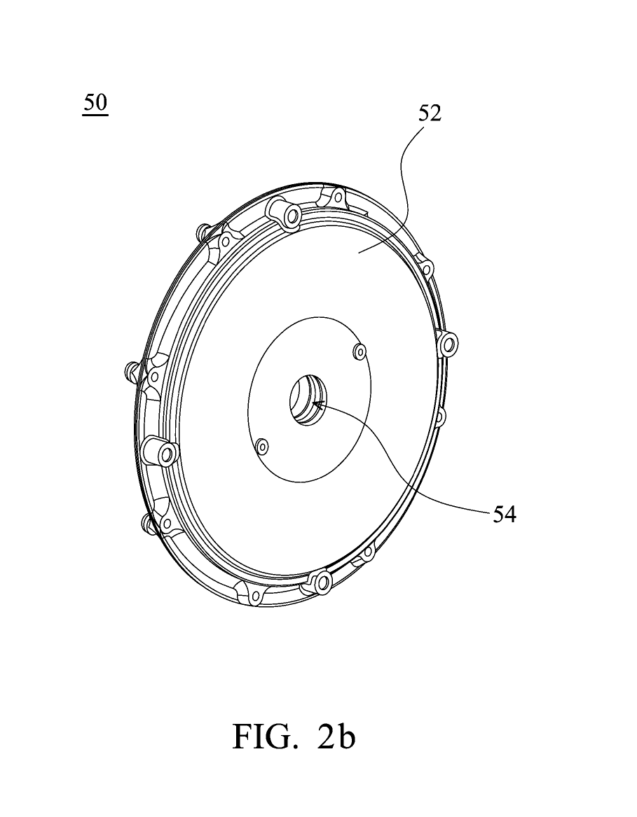

FIGS. 2a and 2b depict a slim motor 50 of the present disclosure. As the slim motor 50 has axial magnetic flux, the magnetic flux area of the slim motor 50 is larger than that of the conventional outer-rotor motor, whereas the size is smaller than that of the conventional outer-rotor motor. The thickness of the conventional outer-rotor motor is over 10 cm, whereas the thickness of the slim motor 50 is only about 3 cm. The slim motor 50 is suitable for an electric bicycle due to its torque, size and weight advantages. The torque generated by the slim motor 50 is large enough to drive a bicycle without any transmission mechanism. The slim motor 50 can be an outer-rotor type or inner-rotor type motor according to requirements. The detailed structure of the slim motor 50 is described as follows.

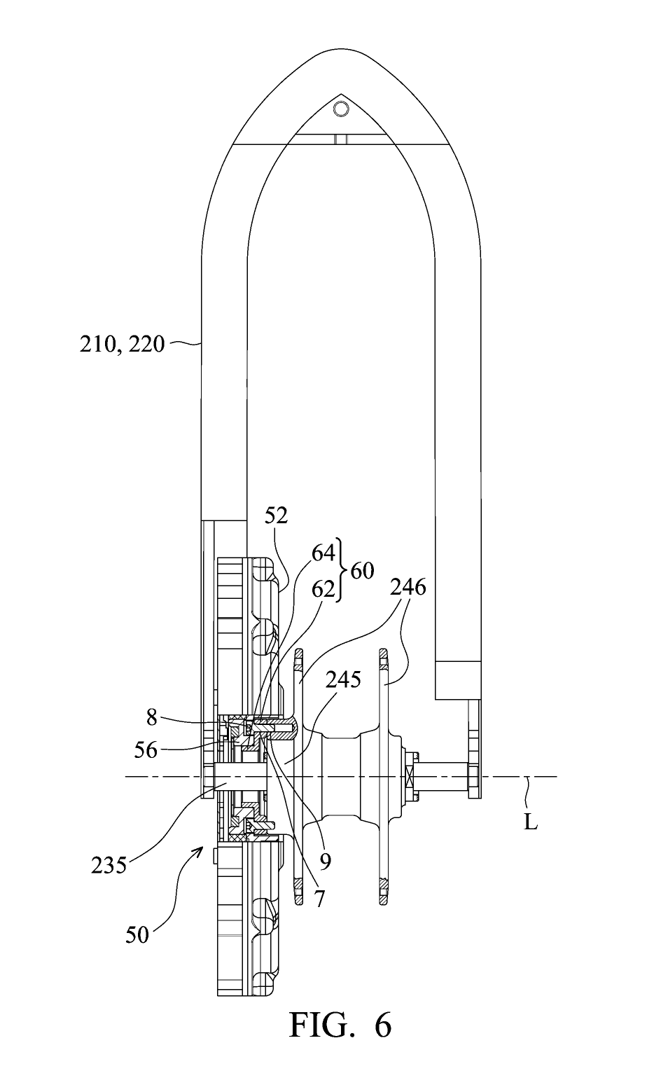

The slim motor 50 comprises a housing 52 having a disc shape with a through hole 54. In this embodiment, the through hole 54 is formed on the center of the housing 52. The wall of the through hole 54 is connected to a rotor 56 (see FIG. 6) which rotates about an axis passing through the through hole 54.

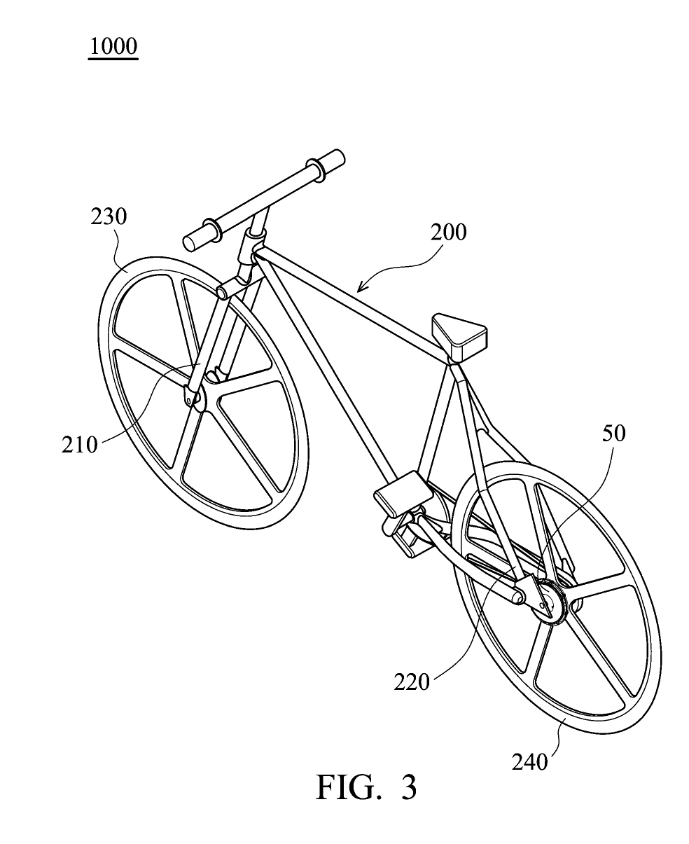

Referring to FIG. 3, an electric bicycle 1000 of the present disclosure comprises a frame 200 having a front supporting member (front fork) 210 supporting a front wheel 230 and a rear supporting member (rear fork) 220 supporting a rear wheel 240. The slim motor 50 is mounted between the rear supporting member 220 and a rear wheel 240 of the electric bicycle 1000. The axis of the slim motor 50 is aligned with a shaft of the rear wheel 240 (shown in FIG. 7). The slim motor 50 can be secured on the rear supporting member 220 to rotate the rear wheel 240, whereby the torque of the slim motor 50 is directly transmitted to the rear wheel 240.

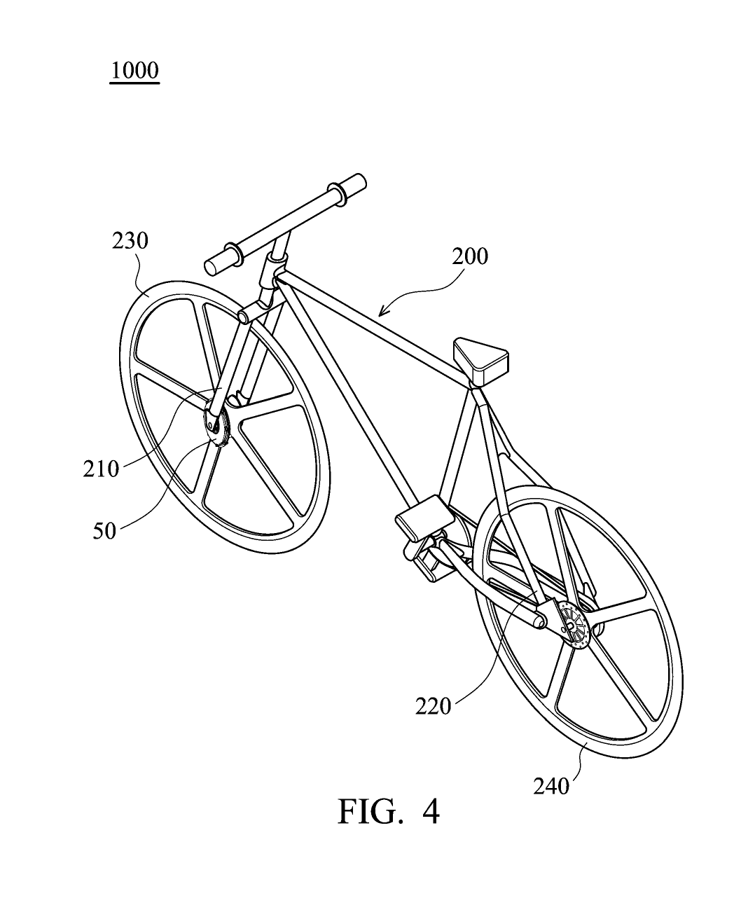

Referring to FIG. 4, the slim motor 50 can also be mounted between the front supporting member 210 and the front wheel 230. The slim motor 50 is secured on the front supporting member 210 to directly rotate the front wheel 230.

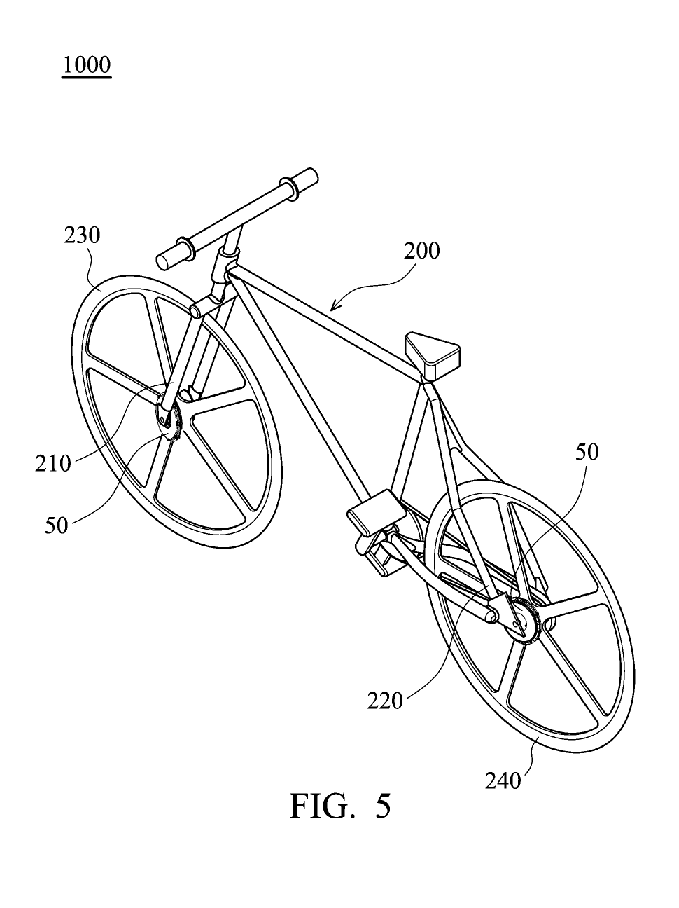

Referring to FIG. 5, the slim motors 50 are mounted on both the front wheel 230 and the rear wheel 240 to increase the torque transmitted to the electric bicycle.

When a rider steps on a pedal to manually move a bicycle, the slim motor 50 generates torque to drive the bicycle simultaneously so as to help the rider to move the bicycle more easily. In addition, the electric bicycle 1000 can also be only operated by the slim motor 50, and in such a condition, it would be a pure electric bicycle.

FIG. 6 depicts a cross section view of the slim motor 50 mounted between a supporting member (the front supporting member 210 or rear supporting member 220) and a wheel (front wheel 230 or rear wheel 240). The slim motor 50 is fixed to the supporting member 210, 220. The wheel 230, 240 has a shaft 235 extending through the through hole 54 of the slim motor 50 and fixed to the supporting member 210, 220. The axis L of the slim motor 50 is aligned with the shaft 235. A hub 245 on which the wheel 230, 240 (not shown in FIG. 6) are mounted rotates about the shaft 235. Brake discs 246 are mounted on the hub 245 to rotate with the hub 236 with respect to the shaft 235. The hub 236 is coupled to the rotor 56 by an adapter 60. The adapter 60 has a connecting portion 62 and a fitting portion 64. The fitting portion 64 is a flange perpendicular to the connecting portion 62. The fitting portion 64 is tightly fitted with the rotor 56 of the slim motor 50. The connecting portion 62 has a first screw hole 7 corresponding to a second screw hole 9 formed on the hub 246. A bolt 8 passes through the first and second screw holes 7 and 9 to join the adapter 60 to the hub 236. The second screw hole 9 can serve as a locking hole of the brake disc 246. The rotor 56 rotates the hub 236 about the axis L via the adapter 60 so as to rotate the wheel 230, 240 about the axis L.

While the present disclosure has been described by way of example and in terms of preferred embodiment, it is to be understood that the present disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electric bicycle, comprising:
a frame comprising at least one supporting member;
at least one wheel comprising a shaft fixed to the supporting member and a hub rotatable about the shaft; and
at least one slim motor comprising a rotor coupled to the hub and rotating about an axis aligned with the shaft, wherein the slim motor drives the hub to rotate about the shaft.

2. The electric bicycle as claimed in claim 1, wherein the rotor is coupled to the hub by a coupling element.

3. The electric bicycle as claimed in claim 2, wherein the coupling element is an adapter tightly fitted to the rotor.

4. The electric bicycle as claimed in claim 3, wherein the adapter comprises a connecting portion having a first screw hole corresponding to a second screw hole formed on the hub, and a fitting portion connected to the connecting portion and tightly fitted to the rotor, wherein a bolt passes through the first and second screw holes to fix the adapter to the hub.

5. The electric bicycle as claimed in claim 4, wherein the fitting portion is perpendicular to the connecting portion.

6. The electric bicycle as claimed in claim 4, wherein the slim motor further comprises:
a housing having a disc shape with a through hole through which the axis passes; and
a stator disposed in the housing and corresponding to the rotor, wherein the rotor is disposed in the housing and around the through hole.

7. The electric bicycle as claimed in claim 6, wherein the fitting portion extends into the through hole and is tightly fitted with the rotor.

8. The electric bicycle as claimed in claim 6, wherein the through hole is formed at the center of the housing.

9. The electric bicycle as claimed in claim 1 further comprising a front wheel having a front shaft and a front hub rotatable about the front shaft and a rear wheel having a rear shaft and a rear hub rotatable about the rear shaft, wherein the frame comprises a rear supporting member to which the rear shaft is fixed and a front supporting member to which the front shaft is fixed.

10. The electric bicycle as claimed in claim 9, wherein the axis is aligned with the rear shaft and coupled to the rear hub, and the slim motor drives the rear hub to rotate about the rear shaft.

11. The electric bicycle as claimed in claim 9, wherein the axis is aligned with the front shaft and coupled to the front hub, and the slim motor drives the front hub to rotate about the front shaft.

12. The electric bicycle as claimed in claim 9 further comprising a plurality of slim motors, wherein at least one slim motor has an axis aligned with the rear shaft and coupled to the rear hub to drive the rear hub to rotate about the rear shaft, and at least another slim motor has an axis aligned with the front shaft and coupled to the front hub to drive the front hub to rotate about the front shaft.
